(19) United States
(12) Patent Application Publication
(10) Pub. No.: US 2003/0129324 A1
(43) Pub. Date: Jul. 10, 2003

(54) Synthesis of films and particles of organic molecules by laser ablation

(75) Inventors: Francois Y. L. Genin, Berkeley, CA (US); Brent C. Stuart, Livermore, CA (US)

Correspondence Address: Michael C. Staggs, Assistant Laboratory Counsel, Lawrence Livermore National Laboratory, P.O. Box 808, L-703, Livermore, CA, 94551, US

(73) Assignee: The Regents of the University of California

(21) Appl. No.: 10/238,470

(22) Filed: Sep. 9, 2002

Related U.S. Application Data
(60) Provisional application No. 60/318,043, filed on Sep. 7, 2001.

(51) Int. Cl. H05H 1/24; H05B 7/00

(52) U.S. Cl. 427/569; 427/596

(57) ABSTRACT

The invention relates to a pulsed laser deposition method to produce a plume of material that can be collected as a monolayer or multilayer film or to produce particles of target starting material on a substrate material without substantially decomposing it and without substantially altering its original composition.

### RELATED APPLICATION

This application claims the benefit of U.S. Provisional Application No. 60/318,043, filed Sep. 7, 2001, and entitled, “Synthesis of Films and Nanoparticles of Organic Molecules by Laser Ablation,” which is incorporated herein by this reference.

The United States Government has rights in this invention pursuant to Contract No. W-7405-ENG-48 between the United States Department of Energy and the University of California for the operation of Lawrence Livermore National Laboratory.

### BACKGROUND OF THE INVENTION

1. Field of the Invention

The present invention relates generally to the production of film coatings and particles. More specifically, it pertains to the production of organic and polymer materials and biomolecules by pulsed laser deposition.

2. State of Technology

Pulsed laser deposition has been extensively applied to a large class of materials ranging from ceramics, high purity carbon, and polymers to produce high purity films, limited only by the purity of the target.

Background information on diamond-like thin film coatings by pulsed laser deposition is contained in International Application No. WO 00/22184 entitled “Laser Deposition Of Thin Films,” to Perry et al., patented Apr. 20, 2000, including the following:

“[i]n the present invention, deposition rates is a function of laser wavelength, laser fluence, laser spot size, and target/substrate separation. The relevant laser parameters are shown to ensure particulate-free growth . . . ”

Background information on very high surface quality thin film coatings by pulsed laser irradiation is contained in International Application No. WO 99/13127 entitled “Thin Films of Amorphous and Crystalline Microstructures Based on Ultrafast Pulsed Laser Deposition,” to Rode et al., patented Mar. 18, 1999, including the following: “[p]owerful nanosecond-range lasers using low repetition rate pulsed laser deposition produce numerous macroscopic size particles and droplets, which embed in thin film coatings. This problem has been addressed by lowering the pulse energy, keeping the laser intensity optional for evaporation, so that significant numbers of macroscopic particles and droplets are no longer present in the evaporation plume. The result is deposition of evaporated plume on a substrate to form thin film of very high surface quality.”

Background information on polymer film deposition by pulsed laser evaporation is contained in U.S. Pat. No. 5,192,580 entitled “Process For Making Thin Polymer Film By Pulsed Laser Evaporation,” patented Mar. 9, 1993 and U.S. Pat. No. 5,288,528 entitled “Process For Producing Thin Polymer Film By Pulsed Laser Evaporation,” patented Feb. 22, 1994, both to Blanchet-Fincher respectively, including the following: “[t]his invention comprises an improved process for producing a thin film of addition polymer on a substrate by laser ablation of a target polymer wherein the molecular weight of addition polymer is controlled. In a process for producing a thin film of an addition polymer on a substrate by bombarding a target polymer with radiation from a pulsed laser in a vacuum or gas atmosphere to form a plume of the components of the target polymer which undergo a repolymerization reaction and are deposited on a thin film, the improvement comprises modifying the molecular weight of the addition polymer of the deposited film by conducting the deposition in the presence of at least one additive comprising a chain transfer agent or polymer initiator.”

### SUMMARY OF THE INVENTION

Accordingly, the present invention provides a pulsed laser deposition method to produce a thin film of starting material that does not substantially decompose upon deposition.

Another aspect of the present invention is to provide a deposition method involving one or more laser pulses each having a pulse-width less than 25 picoseconds, rotating and translating a deposition material comprising a biomolecule within a vacuum chamber, directing the laser pulses at said rod to produce a predetermined plasma comprising the biomolecule material, positioning a substrate to be in a path of the plasma; and adjusting one or more deposition parameters to produce a substantially non-decomposing thin film comprising the biomolecule material on the substrate.

A further aspect of the present invention is to provide a deposition method involving one or more laser pulses each having a pulse-width less than 25 picoseconds, rotating and translating a cellulose containing deposition material within a vacuum chamber, directing the laser pulses at the rod to produce a predetermined plasma including the cellulose containing deposition material, positioning a substrate to be in a path of the plasma; and adjusting one or more deposition parameters to produce a substantially non-decomposing thin film containing the cellulose containing deposition material on the substrate.

Accordingly, the present invention provides a short pulse (120 picoseconds or less) laser deposition method to produce quality films with properties that are substantially the same as the starting deposition material. Such quality films including polymers, peptides, proteins, DNA and plastics can be attached to any surface with a wide range of commercial applications in the medical, biotechnology and chemical industry fields.

### BRIEF DESCRIPTION OF THE DRAWINGS

The accompanying drawings, which are incorporated into and form a part of the disclosure, illustrate an embodiment of the invention and, together with the description, serve to explain the principles of the invention.

FIG. 1 shows a cross-section of a deposition chamber used in the present invention.

FIG. 2 shows a cross-section of a second deposition chamber used to study the plume formation of the present invention.

FIG. 3 shows a set of three SEM optical photomicrographs of polyethylene films deposited using different laser pulse-widths.

FIG. 4 illustrates FTIR spectra of SEM photomicrographs taken after deposition by the method of the present invention.

FIG. 5 illustrates the production of cellulose films by a set of before and after SEM optical micrographs at two different magnifications.

### DETAILED DESCRIPTION OF THE INVENTION

Referring now to the following detailed information, and to incorporated materials; a detailed description of the invention, including specific embodiments, is presented.

Unless otherwise indicated, all numbers expressing quantities of ingredients, constituents, reaction conditions and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the subject matter presented herein. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the subject matter presented herein are approximations, the numerical values set forth in the specific examples are reported as precisely as possible. Any numerical value, however, inherently contain certain errors necessarily resulting from the standard deviation found in their respective testing measurements.

General Description

The present invention provides a pulsed laser deposition (PLD) method of producing a thin film of sensitive functional group materials, i.e., materials easily destroyed by bond scission processes or other unwanted reactions, on a substrate. A related system and method of pulsed laser deposition is disclosed and claimed in International Publication No. WO 00/22184, titled “Laser Deposition of Thin Films,” by Perry et al., patented Apr. 20, 2000, and is herein incorporated by reference in its entirety.

As laser light strikes a material, a sequence of events can take place. First, the electromagnetic wave interacts with electrons at the surface of the material. The process of energy deposition into the material can begin. Various mechanisms can operate to transfer this energy into the lattice. As the amount of energy deposited increases, the material can heat up, melt, vaporize, and even be ionized. Above a given threshold, plasma formation and ablation of the surface can occur. This initial step is critical in determining the state of the ablated material. Once ablated, the material expands into the surrounding gas or vacuum and can be collected a distance away from the target. Under such deposition conditions, the flux of the material no longer depends directly on the partial vapor pressure of the multi-element system that must be deposited. In particular, this method takes advantage of being able to attain thermodynamic states that are far from equilibrium.

Specific Description

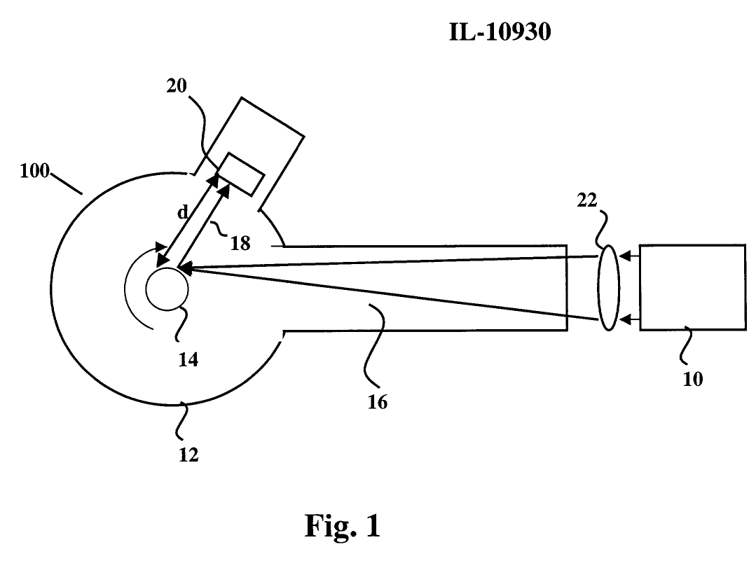

Referring to FIG. 1, a system, generally designated as reference numeral 100, for ablating a target rod 14, includes a 4W average power, less than 120 ps, preferably less than 25 ps, laser system 10 and a 6 inch diameter vacuum chamber 12 operating at a base pressure of 2×10e−6 Torr. Laser 10 is a chirped-pulse-amplification system that can use a Ti:sapphire regenerative amplifier operating at wavelengths from about 90 nm to about 11 microns, and in another embodiment, at about 810 nm, and a 1 kHz repetition rate to provide a millijoule-level pulse every millisecond. However, a laser system having less than a 25-ps laser pulse-width with a power level and a predetermined wavelength capable of performing laser ablation to the design parameters of the present invention may also be employed.

Vacuum chamber 12 includes a 25 mm target rod 14 rotated about its long axis that is perpendicular to a laser beam 16. Beam 16 illuminates rod 14 at a 45° angle of incidence so as to direct a plasma plume 18 toward a substrate 20 held by a 12 mm inside diameter×25 mm outside diameter aluminum cylinder (not shown). Rod 14 is translated back and forth during deposition with a speed of 0.5 mm/s so that the same location is not illuminated with beam 16 immediately after the previous pulse. A 450-mm focal length, plano-convex lens 22 can control the spot size on the target by a translation to and from rod 14 with the beam waist generally located behind the ablation surface. In one embodiment, the distance, (denoted by d in FIG. 1) from rod 14 to substrate surface 20 to control film deposition is varied from a distance range from about 20 mm to about 1000 mm. In another embodiment the distance is about 50 mm, by moving the substrate assembly (not shown) in or out.

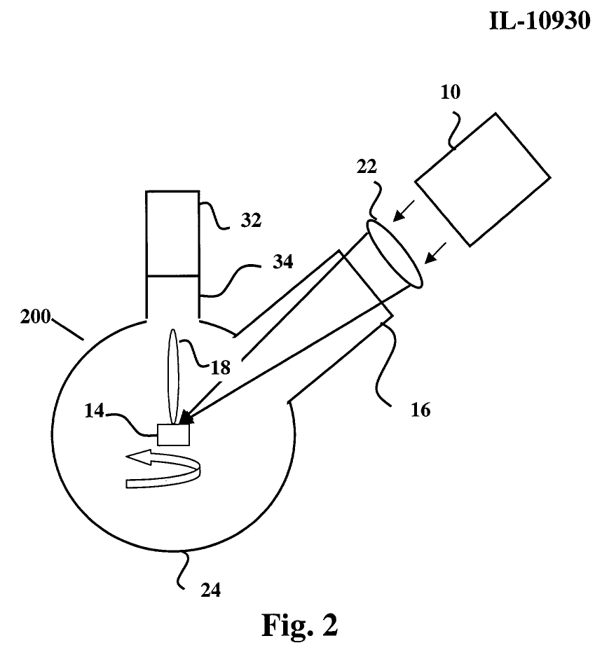

Turning to FIG. 2, a system, generally designated as reference numeral 200, includes a stainless steel vacuum system 24 having a total height of 6 feet, to replace vacuum system 12 shown in FIG. 1, in order to study the characteristics of abated plume 18. A commercial (R. Jordan Company, Grass Valley, Calif.) Time-of Flight Mass Spectrometer (ToF-MS) 32 having an 18-mm and a 40-mm set of micro-channel plate detectors (not shown) interfaced with a commercial (Ortec Fastflight, Perkin Elmer Instruments) signal averager (not shown) and a fast preamplifier (not shown) for data collection is mounted on a top vessel 34. Extraction grids (not shown) are powered with a high voltage power supply triggered with a set of pulse generators (not shown). Laser 10, lens 22, to produce laser beam 16 such that rotating target rod 14 is illuminated with the requisite intensities to produce plume 18 are the same elements as shown in FIG. 1.

Referring to FIG. 1 and FIG. 2, laser beam 16 is substantially diffraction-limited, and the spot size on rod 14 is determined by calculating the ideal gaussian spot size at a predetermined distance x (not shown) from the waist position. The waist position was determined by reducing the fluence incident on the target and moving the lens to maximize the brightness of the plasma observed. The spot size on the target was then adjusted by moving lens 22 closer to rod 14 by the appropriate amount and the incident energy was varied accordingly to adjust the beam intensity.

Thin films including but not limited to silicon, silicon silicon, titanium silicon, lead zirconate-titanate, aluminum nitride, boron nitride, gallium arsenide, polymers (e.g., polyvinyl, polyester, polyethylene, polyanyline and polyacrylic and other highly unstable materials), and cellulose from paper and wood, are grown either in a vacuum or in a buffer or reactive gas at room temperature. Of particular interest is the transfer of biomolecules selected from peptides, proteins, single strand DNA, double strand DNA, proteins, peptides or other polymeric chains, sucrose, glucose, polyglycerides, polylactic acid, and other life building blocks, drugs (e.g., antibiotics such as cyprofloxacin, penicillin, anticancer agents, aspirin), and vitamins, and similar materials such as gelatin, collagen, and dipicolinic acid to a target substrate. These materials can be in the form of solids or liquids (i.e., if the vapor pressure is such that the liquid does not evaporate too quickly prior to the deposition process of the present invention).

The present invention provides films having a thickness from about 0.5 nm to about 5 mm and particle sizes measured from the longest cross-sectional area between about 2 nm to about 50 microns, to be deposited on, but not limited to target substrate materials such as (111) single crystal silicon wafers, 1″ fused silica windows, substrates prepared by lithography to measure thermal conductivity, and 30-nm thick silicon nitride membranes used for TEM characterization.

The deposition rates are calibrated by depositing films onto polished silicon substrates with a mask, and measuring the step height at the edge of the mask by profilometry. Depending on their nature, the films are characterized using Scanning Electron Microscopy (SEM), Transmission Electron Microscopy (TEM), Atomic Force Microscopy, spectral ellipsometry, electron energy loss spectroscopy (EELS), Fourier Transform Infra-red Spectroscopy (FTIR), and Raman spectroscopy. Run to run variations are quantified by measuring resultant film thicknesses after a series of runs. Films of thickness ranging from 0.5 nm to 5 mm are grown for incident intensities varying from about 2×10⁹ to about 2.7×10¹³ W/cm² and a beam spot size between about 50 μm and about 5 mm that is determined by the power available on the laser.

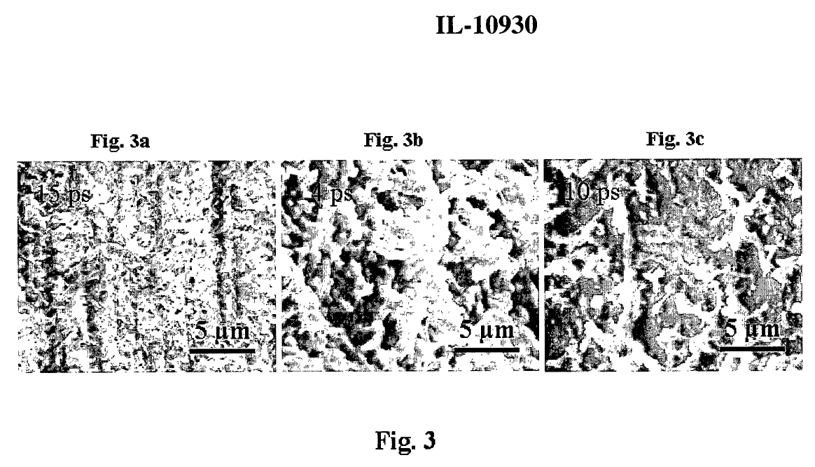

FIG. 3 shows a set of three SEM optical photomicrographs of polymer-containing materials, such as, polyethylene films deposited using different laser pulse-widths with a denoted scale of 5 μm located in the bottom right corner of each photograph for reference as to the magnification field of view. The polyethylene films are produced by using a 15 ps laser pulse-width as shown in FIG. 3a, a 4 ps laser pulse-width as shown in FIG. 3b, and a 10 ps laser pulse-width as shown in FIG. 3c. Each photograph illustrates that polymer chains of polyethylene material can be substantially deposited without chemical dissociation by using pulse-widths that are less than 20 ps.

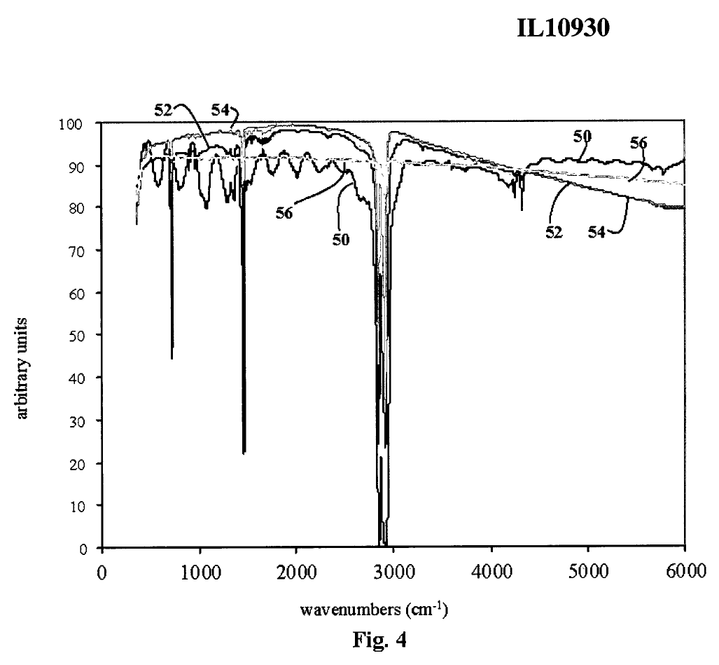

FIG. 4 illustrates FTIR spectra showing arbitrary units versus wavenumbers of the three SEM photomicrographs shown in FIG. 3. An 11 μm reference film 50 spectra, the 15-ps pulse-width deposited film as shown in FIG. 3a is illustrated by a spectra plot 52, the 4-ps pulse-width deposited film as shown in FIG. 3b corresponds to a spectra plot 54, and the 10-ps pulse-width deposited film as shown in FIG. 3c is represented by a spectra plot 56. Each respective plot when compared with reference film plot 50, has polyethylene spectral features throughout the spectral bandwidth illustrated in FIG. 4 to confirm that the polyethylene structure is substantially preserved by deposition (i.e., is substantially deposited on a substrate) at less than 20 ps. Except for the pulse width variation, the films were all prepared under the same experimental intensity conditions. The change of intensity of the FTIR spectra only reflects the fact that the amount deposited onto the substrate decreases with increasing pulse width. This effect is partially caused by the increased degree of disassociation of the molecules with longer pulses. Although the chemical nature of the molecule is preserved, the SEM characterization, as shown in FIG. 3, indicates that the microstructure can be modified.

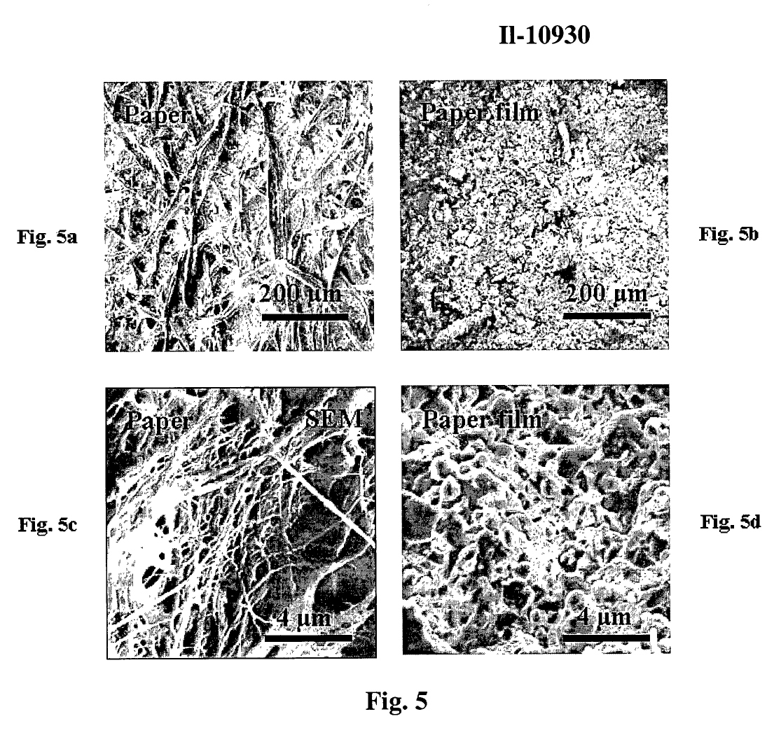

Using 150 femtosecond pulses, 2.5 Watts, at 1 kHz, cellulose-containing materials, such as paper films, having clusters of cellulose were produced upon deposition on a substrate material. FIG. 5 illustrates the production of such films by a set of before and after SEM optical micrographs with indicated magnification scale levels of 200 and 4 μm in FIGS. 5a and 5b, and in FIGS. 5c and 5d respectively, for a field of view perspective for both before and after micrographs. FIG. 5a shows a micrograph with a 200-μm reference magnification scale that illustrates the starting paper material's fibrous composition. FIG. 5b shows a micrograph of the as-deposited paper material having the same magnification scale as shown in FIG. 5a, illustrating a thin film of nano-clusters of original starting paper material. FIGS. 5c and 5d show SEM micrographs of a localized area of the paper material as shown in FIGS. 5a and 5b, but at a higher magnification as designated by the 4-μm scale references respectively shown in each micrograph. FIG. 5c illustrates in greater detail the fibrous structure of the paper material while FIG. 5d illustrates how the fibrous composition of FIG. 5c appears as redeposited clusters of paper material.

From a thermodynamic viewpoint, when laser intensities are sufficiently high, explosion, i.e., explosive phase separation, produces homogenous bubble nucleation when the electrons in the target deposition material reach very high temperatures greater than about 0.907T_{tc}, where T_{tc} is the thermodynamic critical temperature. Such a suggestion is disclosed in “Delayed phase explosion during high power nanosecond laser ablation of silicon,” by Quanming Lu et al., publication pending. Lu et al. states, “According to thermodynamic theory of explosive boiling, the liquid begins to be superheated and becomes metastable when it exceeds a temperature limitation of 0.80T_{tc}. Above this temperature, homogeneous bubble nucleation may occur and the “liquid” is essentially a mixture of liquid droplets and vapor which can facilitate explosive boiling.” Accordingly, the surface of the target deposition material can abruptly transform from a superheated phase into a mixture of clusters and vapor. The clusters are ejected and cool down sufficiently quickly to preserve the molecular structure and chemical bonding of the target material.

Leonid V. Zhigilei, discloses a further explanation of the plume formation during pulsed laser deposition in “Dynamics of the plume formation and parameters of the ejected clusters in short-pulse laser ablation,” Appl. Phys, A, submitted 2002. Zhigilei states: “At sufficiently high laser fluences, the phase explosion of the overheated material leads to the formation of a foamy transient structure of interconnected liquid regions that subsequently decomposes into a mixture of liquid droplets, gas-phase molecules, and small clusters.” In the thermal confinement region, (i.e., where the pulse duration τₜₕ is short relative to the characteristic thermal diffusion time across the absorption depth, τₜₕ about 10 ns, but longer than the time of mechanical equilibrium of the absorbing volume, τₜₛ about 20 ps), the decomposition of an ablated material results in large clusters formed in the region adjacent to the ablated surface, medium-sized clusters in the middle of the plume, and small clusters are formed in the top of the plume. In the regime of stress confinement (i.e., τₜₛ less than about 20 ps), high thermoelastic pressure due to fast energy deposition produces a faster decomposition rate of the ablated material. The result for intensities far above the ablation threshold operating in the stress confinement regime is the ejection of larger droplets and the formation of larger and more numerous clusters. As the intensity is decreased, the fraction of clusters in the ejected plume increases and the maximum size of the ejecta droplets becomes larger in both thermal and stress confinement regimes. For the same laser intensity under the stress confinement regime, the sizes of the droplets are always larger and the droplets constitute a larger portion of the plume in the stress confinement regime as compared to the thermal confinement regime. At intensities closer to the ablation threshold, most of the ejected material can be ejected as a few large clusters or even a single cluster. As the laser intensity approaches the ablation threshold, a layer of intact material separates from the bulk and is ejected intact under the stress confinement illumination conditions. Therefore, there is an empirically selected intensity (W/cm² ), between about the ablation threshold and about an intensity that produces liquid droplets, gas-phase molecules and small clusters, combined with other deposition parameters such as, but not limited to, substrate distance from the target starting fragile material, that can produce a substantially non-decomposing thin film, i.e., a deposited film that retains substantial physical, chemical, and biological properties, etc., of the starting material.

Accordingly, the present invention provides deposition parameters as to produce a thin monolayer or multilayer film or to produce particles of target starting material on a substrate material without substantially decomposing from its original composition.

The experimental parameters are given as an example, but are not intended to limit the scope of the invention. The process is not limited to a vacuum environment. Parameters such as spot size, angle of incidence, laser fluence, laser pulse energy, laser wavelength, distance from target to substrate, etc., can vary from the disclosed embodiments. In addition, it is possible that the variations in parameters will produce films with different properties. It should be understood that the invention is not intended to be limited to the particular forms disclosed. Rather, the invention is to cover all modifications, equivalents, and alternatives falling within the spirit and scope of the invention as defined by the following appended claims.

The invention claimed is:

1. A deposition method, comprising:
positioning a substrate in a path of a predetermined plasma,
producing said plasma comprising a deposition material; and
adjusting one or more deposition parameters to produce a substantially non-decomposed plume comprising said deposition material, wherein said plume is deposited on said substrate.

2. The method of claim 1, wherein said deposition material comprises an organic material.

3. The method of claim 2, wherein said organic material comprises a cellulose containing material selected from paper and wood.

4. The method of claim 1, wherein said deposition material comprises a biomolecule selected from DNA, proteins, peptides, sucrose, glucose, polyglycerides, polylactic acid, drugs, vitamins, gelatin, collagen, and dipicolinic acid.

5. The method of claim 4, wherein said deposition material further comprises reactive organic materials that can attach to said DNA.

6. The method of claim 1, wherein said deposition material comprises a polymer selected from polyethylene, polyanyline polyvinyl, polyester and polyacrylic.

7. The method of claim 1, wherein said deposition material comprises a thin film selected from silicon, silicon silicon, titanium silicon, lead zirconate-titanate, aluminum nitride, boron nitride, and gallium arsenide.

8. The method of claim 1, wherein said substantially non-decomposing thin film comprises a multilayer.

9. The method of claim 1, wherein said substantially non-decomposing thin film comprises a plurality of nanoparticle clusters.

10. The method of claim 9, wherein said nanoparticle clusters have a particle size from about 2 nm to about 50 microns.

11. The method of claim 1, wherein said substantially non-decomposing thin film has a thickness from about 0.5 nm to about 5 mm.

12. The method of claim 1, wherein said deposition parameters includes one or more laser pulses each having a pulse-width less than about 120 ps.

13. The method of claim 1, wherein said deposition parameters includes one or more laser pulses each having a pulse-width less than about 25 ps.

14. The method of claim 1, wherein said deposition parameters includes one or more laser pulses having a wavelength from about 90 nm to about 11 microns.

15. The method of claim 1, wherein said deposition parameters includes one or more laser pulses having a wavelength of about 810 nm.

16. The method of claim 1, wherein said deposition parameters includes one or more laser pulses having an intensity from about 2×10⁹ to about 2.7×10¹³ W/cm² incident upon said deposition material.

17. The method of claim 1, wherein said plasma comprises a center plume substantially directed at the center of said substrate.

18. The method of claim 1, wherein said deposition parameters includes a deposition material separated from said substrate by a distance from about 20 mm to about 1 meter.

19. The method of claim 1, wherein said deposition parameters include a deposition material separated from said substrate by a distance from about 40 to about 60 mm.

20. The method of claim 1, further comprising:
providing one or more laser pulses; and
directing said one or more laser pulses at said deposition material to produce said plasma.

21. A deposition method, comprising:
providing one or more laser pulses each having a pulse-width less than 25 picoseconds,
rotating and translating a rod of deposition material comprising a biomolecule within a vacuum chamber,
directing said laser pulses at said rod to produce a predetermined plasma comprising said biomolecule material,
positioning a substrate to be in a path of said plasma; and
adjusting one or more deposition parameters to produce a substantially non-decomposed plume comprising said biomolecule material, wherein said plume is deposited on said substrate.

22. The method of claim 21, wherein said deposition parameters includes said laser pulses having an intensity from about 2×10⁹ to about 2.7×10¹³ W/cm² incident upon said deposition material.

23. The method of claim 21, wherein said deposition parameters include said laser pulses having a wavelength from about 90 nm to about 11 microns.

24. The method of claim 21, wherein said deposition parameters includes said laser pulses having a wavelength of about 810 nm.

25. The method of claim 21, wherein said deposition material comprises a biomolecule selected from DNA, proteins, peptides, sucrose, glucose, polyglycerides, polylactic acid, drugs, vitamins, gelatin, collagen, and dipicolinic acid.

26. The method of claim 21, wherein said substantially non-decomposing thin film comprises a plurality of nanoparticle clusters.

27. The method of claim 26, wherein said nanoparticle clusters have a particle size range from about 2 nm to about 50 microns.

28. A deposition method, comprising:
providing one or more laser pulses each having a pulse-width less than 25 picoseconds,
rotating and translating a rod of cellulose containing deposition material,
directing said laser pulses at said rod to produce a predetermined plasma comprising said cellulose containing deposition material,
positioning a substrate to be in a path of said plasma; and
adjusting one or more deposition parameters to produce a substantially non-decomposed plume comprising said cellulose containing deposition material, wherein said plume is deposited on said substrate.

29. The method of claim 28, wherein said cellulose containing deposition material is selected from wood and paper.

30. The method of claim 28, wherein said deposition parameters includes said laser pulses having an intensity range from about 2×10⁹ to about 2.7×10¹³ W/cm² incident upon said deposition material.

31. The method of claim 28, wherein said deposition parameters includes said laser pulses having a wavelength range from about 90 nm to about 11 microns.

32. The method of claim 28, wherein said deposition parameters includes said laser pulses having a wavelength of about 810 nm.

33. The method of claim 28, wherein said substantially non-decomposing plume comprises a plurality of nanoparticle clusters.

34. The method of claim 34, wherein said nanoparticle clusters have a particle size range from 2 nm to 50 microns.
